(19) United States
(12) Patent Application Publication
(10) Pub. No.: US 2022/0108256 A1
(43) Pub. Date: Apr. 7, 2022

(54) SYSTEM AND METHOD FOR DECISION SYSTEM DIAGNOSIS

(71) Applicant: dcyd, Inc., Millbrae, CA (US)

(72) Inventors: Timothy Eller, Millbrae, CA (US); Robert Sarvis, Millbrae, CA (US)

(21) Appl. No.: 17/493,509

(22) Filed: Oct. 4, 2021

Related U.S. Application Data
(60) Provisional application No. 63/086,979, filed on Oct. 2, 2020.

(51) Int. Cl. G06Q 10/06; G06Q 10/04

(52) U.S. Cl. CPC G06Q 10/06395; G06Q 10/04

(57) ABSTRACT

The disclosure relates to a method for an analysis in a decision system. An example method includes receiving one or more data from a user; inspecting the one or more data; after inspecting the one or more data, training the one or more data; identifying a decision space for the user based on the trained one or more data; training a model to predict an outcome, the outcome being a function of features and decision parameters in the decision space; monitoring a performance of the model in the decision system; receiving a set of features from the user to the model; optimizing the outcome based on the set of features; and displaying the outcome to the user.

### CROSS-REFERENCE TO RELATED APPLICATION(S)

This application claims the benefit of and priority to U.S. Provisional Application No. 63/086,979, filed on Oct. 2, 2020, entitled “SYSTEM AND METHOD FOR DECISION SYSTEM DIAGNOSIS,” which is hereby incorporated by reference in its entirety.

### TECHNICAL FIELD

The present systems and methods are directed to providing a system and a method for diagnosis of a decision system.

### BACKGROUND

Given ever-widening market bases that demand faster response times, decisions are increasingly automated in business. Typical examples are probabilistic fraudulent transaction-blocking, dynamic pricing, and personalized search filtering and ranking. Unfortunately, the systems that make and execute decisions are fallible, as a result of various phenomena.

Moreover, when a decision system falters according to some measure, its opacity and complexity make it arduous to debug. There is always a possibility a decision system will malfunction, and after a point, there is insufficient return on the investment in making a system more robust and less-error prone. Therefore, there is a need to monitor the performance of the system.

### SUMMARY

In one aspect, the subject matter of this disclosure relates to a computer-implemented method for an analysis in a decision system. The method includes: receiving one or more data from a user; inspecting the one or more data; after inspecting the one or more data, training the one or more data; identifying a decision space for the user based on the trained one or more data; training a model to predict an outcome, the outcome being a function of features and decision parameters in the decision space; monitoring a performance of the model in the decision system; receiving a set of features from the user to the model; optimizing the outcome based on the set of features; and displaying the outcome to the user.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a method of a policy factoring through features of a probability space, according to an embodiment of the present disclosure;

FIG. 2 is an objective function model is a function of features and a policy, according to an embodiment of the present disclosure;

FIG. 3 is a graph representation of a modeled objective function in terms of the optimal policy and lower-level models and features, according to an embodiment of the present disclosure;

FIGS. 4 and 5 are dependency graph representations of an exemplary financial application of the system, according to an embodiment of the present disclosure;

FIGS. 6 and 7 are interfaces generated by the system in the present disclosure that have parsed and drawn the resulting dependency graph, according to an embodiment of the present disclosure;

FIG. 8 is a flow chart of a system for decisions as a service (DASH) service, according to an embodiment of the present disclosure;

FIG. 9 is a schematic of a user device for performing a method, according to an embodiment of the present disclosure;

FIG. 10 is a schematic of a hardware system for performing a method, according to an embodiment of the present disclosure; and

FIG. 11 is a schematic of a hardware configuration of a device for performing a method, according to an embodiment of the present disclosure.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

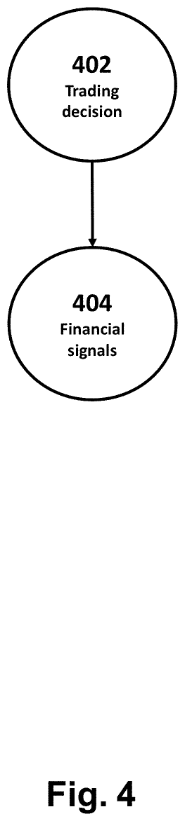

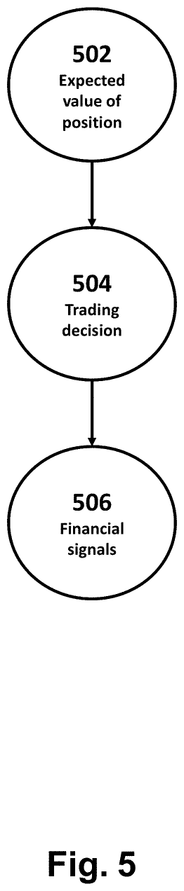

In one embodiment, the system in the present disclosure provides a graph-theoretic structure that underlies many decision-making processes. For example, the decision of whether to buy, sell, or hold a stock at a particular moment may depend on a model that predicts the stock's value one day from now, the inputs to which are a handful of available financial signals. In this case, the collection of financial signals 404 can be represented as a single leaf node in a dependency graph (shown later in FIG. 4 herein), on which depends a node representing the selected trading decision 402 (e.g., either buy, sell, or hold). Another representation (shown later in FIG. 5 herein) is to add another node, expected value of position 502, as a dependent node of both the financial signals and trading decision nodes, representing the expected value of the operator's position given the selected decision.

In one embodiment, the system in the present disclosure identifies and ranks weaknesses within a decision-making process. For example, three inputs into the decision of whether to buy, sell, or hold a stock at a particular moment in order to maximize profits may be its present value, its value one minute ago, and its value two minutes ago. In the event that the labels of the first two inputs erroneously get swapped after they are input into the decision system, the present value may be mislabeled as its value a minute ago; vice versa, the value of the third input erroneously may get doubled after it is input. The system may use statistical means to infer that the labels of the first two inputs were swapped, and that the value of the third input was doubled. The system may estimate how drastically each error is impacting the performance of the decision system, and the system may finally recommend which error is more important to repair.

In one embodiment, the system in the present disclosure includes an algorithm for discovering the graph theoretic structure of a live decision-making system and measures its performance from data logs. For example, the algorithm can ingest a time-ordered set of timestamped data logs generated by function calls and responses. The algorithm can designate a function whose request and response lie between the request and response of a second function. The algorithm makes the first function a dependency of the second function's node. A dependency graph is then produced with multiple connected components. Using a statistical technique such as sensitivity analysis, the algorithm can then discover how sensitive the values in a dependent node are to variations in any of the nodes they depend on. In the event that the decision system is designed to output decisions that improve a business metric such as profit, then if a particular node in its dependency chain is discovered to be errant (e.g., an input that was entered improperly, or a predictive model with weak performance), then the system can estimate the improvements to profit if the errant node can be repaired.

In one embodiment, the system and method in the present disclosure are relevant to automated systems. For example, automated systems may recommend prices of goods dynamically. The automated systems may recommend whether to execute a proposed financial transaction. The automated systems may rank and filter a list of items given a set of search terms.

### Breakage.

In one embodiment, the decision system may have breakage. For example, the decision-making processes may degrade for a number of reasons. The reasons include disconnect between development and deployment, misalignment between objectives of the entire system and objectives of their components, geometric breakage, and topological breakage.

In one embodiment, the disconnect between development and deployment may include a process for developing a decision system which is separate from the process for deploying it in production, and deliberate choices made in the development process are lost or altered in the latter process. For example, a decision system that decides whether to buy, sell, or hold a particular stock when certain conditions are met may rely on the average value of a second stock in the prior minute. When developing this decision system, the model has access to a complete historical record of the average price of the second stock. However, when the decision system is running in production, there is a chance that the online system providing data regarding the second stock fails for a minute or more, in which case the decision system must still make a choice whether to buy, sell, or hold the stock despite having insufficient input data. While this can be repaired, it is not uncommon for this and similar issues to exist in production decision systems, despite best intentions.

In one embodiment, the misalignment between the objectives of the entire system and the objectives of their components includes tuning the performance of a constituent model within a decision system such that it performs well on inputs that ultimately contribute negligibly to the performance of the entire decision system, but must sacrifice its performance on inputs that ultimately contribute heavily to the performance of the entire decision system. For example, a decision system that recommends whether a symptomatic patient receives a certain marginally successful yet expensive treatment only if a model gives a sufficiently high estimate that the patient has a particular disease, and also the model is evaluated by a balance between the amount spent on treatments and the patients' collective health. If the model is tuned to maximize accuracy rather than a more sophisticated balance between a false positive rate and a true positive rate, then it is conceivable that the model may unilaterally predict that nobody ever has the disease given its rarity, further resulting in the decision never to administer the treatment. While treatment costs are certainly minimized, the patients' resulting collective health may be disproportionately bad. The crux of the misalignment is that the model has no awareness of the metric used to evaluate the entire decision system.

In one embodiment, the geometric breakage includes natural environmental dynamics, which create a rift between how the decision system is intended to perform and how it actually performs. For example, a decision system may recommend either a book or a video game to a shopper solely based on the shopper's sex, so that the decision system's constituent models may be trained on data representing young girls that prefer books and young boys that prefer video games. If the audiences evolved into middle-aged women who play social video games and male academics, the system's recommendations may substantially underperform.

In one embodiment, the topological breakage includes a deployed system, which relies on a data preparation process upstream. However, the data preparation process upstream can be brittle. The data preparation process often relies on real-time data provided by third parties. Therefore, the data preparation process is subject to network latency beyond a user's control and to data errors introduced by the third parties. Whenever the data preparation process breaks, so does the downstream process. For example, a decision system that makes stock trades, and the decision system depends on receiving financial signals from third parties. The decision system may make suboptimal trades if the third parties send incorrect data, improperly formatted data, or no data at all.

In one embodiment, the system includes a decision system. The decision system is a function that selects an element from a predetermined set of options when passed a sample from a population. The decision system may include only one policy to make an decision, therefore, the function to make an decision is the policy function. The policy function may be called decision function. For example, a ridesharing company that performs dynamic pricing may have constructed a function that returns a price when passed either a unique identifier for a proposed ride request or features of the proposed ride request, such as start and finish locations and measures of local supply and demand. The predetermined set of options is a set of real numbers (e.g., the possible prices), and the population is a set of ride requests in one or more time intervals. In this example, the function that returns the price is a policy function of the decision system. The function that returns the price can also be called the decision function of the decision system.

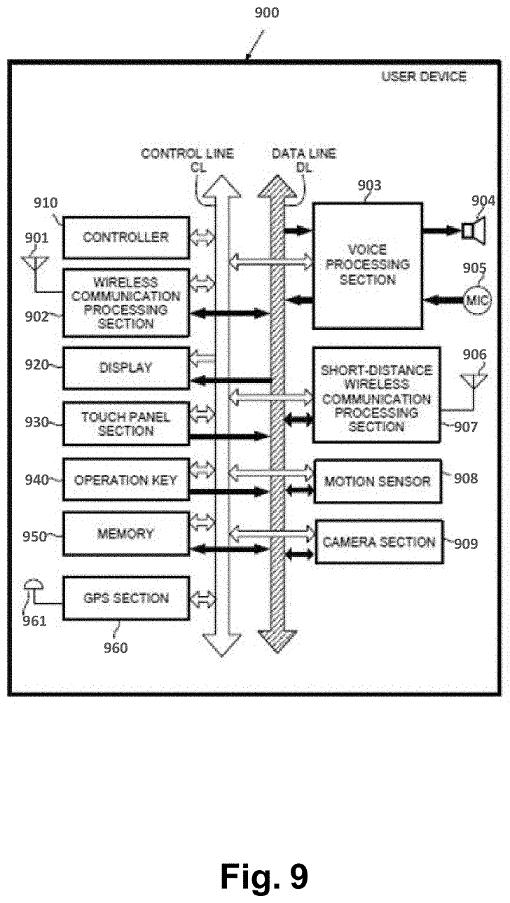

In one embodiment, the decision system has a mathematical objective function, and the decision system's decisions are intended to optimize (e.g., either maximize or minimize) the mathematical objective. For example, the ridesharing company may choose revenue as their objective function and use dynamic pricing as a means to maximize that revenue. For a given user who has specified a particular origin and destination in a user device 900 (discussed later in FIG. 9 herein) for the decision system, and given other environmental conditions such as time of day, the company may determine that charging $10 may result in an amount of revenue higher than if they had charged any other price. That is, charging more than $10 may substantially decrease the likelihood the user would accept the price, and charging less than $10, while possibly increasing the likelihood that the user would accept the price, may result in substantially lower revenue.

In one embodiment, a method for determining an optimal policy is presented. A policy is a function or a process, for a given mathematical objective function, selects a decision intended to optimize that mathematical objective function This method pertains in particular when the mathematical objective function cannot be evaluated for a given decision, for example, when the result of the decision is measured only after the decision has been made. The method in the present disclosure is to substitute the mathematical objective function with a model that approximates the mathematical objective function that can be evaluated on decisions before committing to one, and then to determine a policy that optimizes the model. For example, a ridesharing company that uses dynamic pricing as a mean to optimize its revenue may not be able to know the revenue coming from a proposed ride until after a price has been set and either accepted or rejected by the user. Using this method, the ridesharing company may first create a programmatic model that rapidly estimates the revenue for a variety of origins, destinations, times of day, and at a variety of prices, and then design a policy that optimizes that model.

In one embodiment, the system of the present disclosure is a decision system. The decision system includes a probability space, a decision space, and an objective function. For example, a ridesharing company's decision system may specify the set of ride searches in some region and time intervals as the probability space, the set of all possible prices to charge as the decision space, and revenue as the objective function.

In one embodiment, the probability space may be a population of items or events, a random subset of which is subject to a decision. For example, the probability space may be a segment of population or the entire population. The probability space may also be a collection of subsets of a population. In a case of lead prioritization for a sales team, an entire pool of new leads must be subject to a decision such as in what order to reach out to them simultaneously.

In one embodiment, the decision space may be a fixed set of available options for the elements of the probability space. The fixed set of available options may be non-numeric. For example, the decision space in a decision system that approves or rejects credit card transactions on the basis of the likelihood they are fraudulent and may incur costs rather than bring in revenue may be the set {APPROVE, REJECT, REVIEW}. In the case of lead prioritization for a sales team, the decision space is the set of orderings or permutations of a pool of leads.

In one embodiment, the objective function 202 may be a specified observable random variable that functionally varies with a choice of policy. The policy 102 may be mapping from the probability space to the decision space. The objective function 202 is observable on a sample only after a policy 102 has been chosen. After the objective function 202 has been applied to the sample, it may take between a few seconds and a few months for its value to become known. For example, a car leasing agency may have a decision system that approves or rejects applicants, based on the profit associated with each applicant two months after the application is submitted. An approved applicant may generate lots of profit by paying monthly fees on time, or none at all if he or she does not pay the monthly fees. A rejected applicant may not generate any profits. In this case, the objective function 202 is “profit two months after application”, and its value may not be known until two months after the decision to approve or reject has been made. The policy 102 is the process or function that decides whether to approve or reject an applicant on the basis of how it may impact the objective function 202.

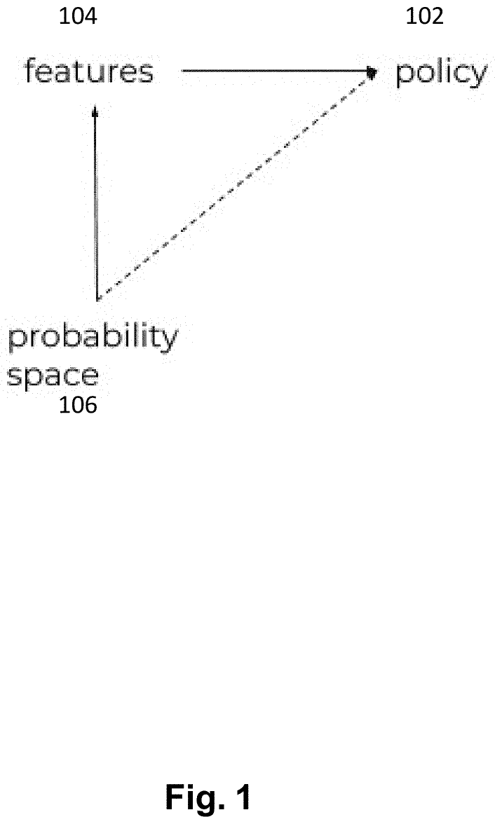

Referring to FIG. 1, this figure illustrates a method of a policy 102 factoring through features of a probability space, according to an embodiment of the present disclosure.

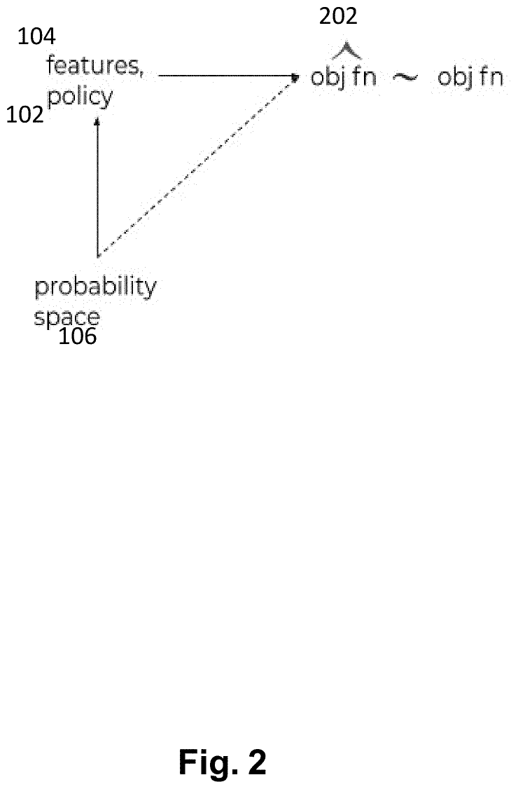

For example, a car leasing agency that has a decision system that either approves or rejects an applicant on the basis of the associated profit (e.g., an objective function 202 discussed later in FIG. 2 herein) two months after the application may design a policy 102 that consumes properties, or features 104, of an applicant, such as age and credit score, estimates the applicant's profit in two months. The decision system then produces a decision whether to accept or reject the applicant. On one hand, the policy 102 is a mapping from an applicant to a decision, but the details reveal that the policy 102 actually depends on features 104 of the applicant.

Referring to FIG. 2, this figure illustrates that an objective function model is a function of features 104 and a policy 102, according to an embodiment of the present disclosure.

For example, the policy 102 such as a near-optimal policy may maximize a statistic of an objective function model 202. The statistic is a functional of the policy 102 and features 104 as shown in Equation 1 (Eq. 1) below.

[symbol]

*=argmax_{Policies} [symbol] Eq. 1

For example, a car leasing agency may have a decision system that decides whether to accept or reject an applicant on the basis of the associated profit two months after the application is processed. The profit may be the objective function 202. Since the profit two months later is not known at the time the decision must be made, the policy 102, which reads features 104 of the applicant such as age and credit score in order to produce a decision, makes use of an estimate of the objective function 202. The policy 102 depends on the features 104 of the applicant in order to produce a decision. In particular, the policy 102 may be designed to select the decision (e.g., accept or reject) that maximizes the estimate of the applicant's associate profit two months later.

In one embodiment, it may be not necessary for the system to evaluate an estimate of the objective function 202. The system in the present disclosure may find an optimal policy by using derivatives of the estimate for the objective function 202, and not the estimate of objective function 202 itself. For example, if a model that estimates an objective function 202 has the form −x\hat{ }2+4x, the optimal value of x can be obtained by taking the derivative, −2x+4, and setting it equal to 0 to reveal that it is optimized when x=4.

In one embodiment, an example is ridesharing pricing. The ridesharing pricing may include a probability space 106, a decision space, and an objection function 202. The probability space 106 may be a set of user searches in one or more bounded spatial regions over a thin time window. The decision space may be a set of real numbers. The objective function 202 may be the revenue which, to produce a policy, is accompanied by a model that estimates revenue as a function of features 104 of the search such as origin and destination, as well the policy, chosen to optimize the estimated revenue.

In this case, a heuristic policy may be a function that counts the number n of available cars within a 1-mile radius of a given search, and offers a price of $25/n.

In some embodiments, an approach to choose a policy 102 may be to create a model that estimates revenue as a function of various prices and of the observed features of a given search, such as local supply and local demand. The model may also rely on the outputs of a second model, for example one that estimates a probability of conversion as a function of those same features at various prices. In an example, a near-optimal pricing policy can be used to optimize the product of price times conversion probability at the price, for a given search.

In one embodiment, an example is a more sophisticated version of rideshare pricing. The ridesharing pricing may include a probability space 106, a decision space, and an objective function 202. The probability space 106 may be a bounded region of spacetime, regarded as a single element. The decision space may be the set of real-valued functions on that spacetime region. The objective function 202 may be the revenue.

In one embodiment, a decision system may need to produce a decision before the subject of the decision is observed. Therefore, based on a set of features of the subject, estimates of those features may be substituted for the features 104. For example, a ridesharing company may need to set prices before the system observes users who will be shown the prices. In this case, the decision system may rely on estimates of the number and features 104 of the users before the preset prices will be shown to the users. Thus, the system in the present disclosure anticipates how the policy 102 in the initial time slice of the region impacts the features 104 before being observed.

In one embodiment, an example is a transaction risk assessment. The transaction risk assessment may include a probability space 106, a decision space, and an objection function 202. The probability space 106 may include a set of proposed transactions in one or more time windows. The decision space may be acceptance or rejection. The objective function 202 may be profit.

In this case, the system of the present disclosure shows models of the expected profit as a function of a given proposed transaction and each possible decision. The system then selects the policy 102 with a higher expected profit. For example, the system may calculate the expected profit assuming the transaction is accepted. The system may calculate the expected profit assuming the transaction is rejected. The system may then select the decision with the higher expected profit.

### Decision Systems as Dependency Graphs.

In one embodiment, when the choice of policy 102 makes use of a model for the objective function 202, it is useful to organize the structure of a decision system as a dependency graph. The system in the present disclosure shows a dependency graph structure that facilitates measurements of the health of a decision system and identifies the location of any weakness.

In the dependency graph of a decision system, each node represents an output of a function or an input to another function. A dependent node represents the output of a function, and a node pointed to that dependent node represents an input into that function.

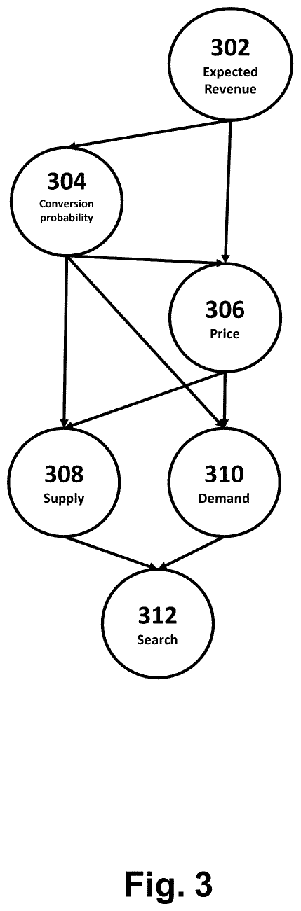

For example, as discussed later in FIG. 3 herein, node 306 is an output of two functions (e.g., demand function represented by the node 310 and supply function represented by the node 308). Therefore, the node 306 is a dependent node to the demand function represented by the node 310 and the supply function represented by the node 308. Furthermore, the price provided from the price function represented by the node 306 is an output of the demand function represented by the node 310 and the supply function represented by the node 308.

In some embodiments, on the other hand, nodes pointed to the node 306 are nodes 302 and 304. Therefore, nodes 302 and 304 are inputs into the price function represented by the node 306. Expected revenue from the expected revenue function represented by the node 302 and conversion probability from the conversion probability function represented by the node 304 are inputs into the price function represented by the node 306.

In the case that the model for the objective function only weakly estimates the actual observed values of the objective function, we may declare that the decision system is unhealthy, and then we can examine the dependencies of that node to see if there is a dependent node or nodes whose anomalous values properties and statistical distributions may be the source of the ailment.

### Constructing the Graph.

Referring to FIG. 3, this figure illustrates a graph representation of a modeled objective function 202 (expected revenue) in terms of the policy 102 and lower-level models and features 104, according to an embodiment of the present disclosure.

In one embodiment, the graph in the present disclosure, the system may attribute fractions of an overall performance of a decision system's chosen policy 102 to various nodes. In addition, a node's performance in the context of the graph is a measure of the intrinsic performance (e.g. accuracy, if the node represents a model) scaled by the extrinsic importance (e.g., how important it is to quantities that depend on it)). For example, the nodes in FIG. 3 include node 302 for expected revenue, node 304 for conversion probability, node 306 for price policy, node 308 for supply, node 310 for demand, and node 312 for search.

In one embodiment, many nodes in the graph (e.g., the source node) represent models. As such, the system in the present disclosure reconciles those models' predictions with the actual outcomes (e.g., post decision). This creates a sort of partial shaded graph of actual outcomes.

In one embodiment, there are 4 types of nodes in the graph such as FIG. 3 mentioned above: a chosen policy, which is a random variable that was constructed analytically; models, including the source node (e.g., the model for the objective function); features 104, which are observed random variables; and an optional sink node representing samples of the underlying population.

In some embodiments, a node's overall performance is related to how much the mean of the observed objective function 202 may increase by repairing that node.

For example, if a particular node is broken in some sense, and the particular node is important to quantities depending on the particular node (and they to their dependent nodes, and so on), then repairing this particular node may cause a large improvement to the objective function 202 and repairing it may be given a high priority. However, if this particular node has sufficiently little importance to dependent nodes of the particular node, and so on, then completely restoring it may not have significant improvement to the objective function 202 and repairing it may have a low priority.

Furthermore, if a particular node has good accuracy, or the particular node is performing well in some sense but has overwhelming impact on dependent nodes of the particular node such that increasing the performance of the particular node by even a small amount may greatly impact the observed objective function 202, then this particular node may have a medium priority. Least priority is given to a node that is functioning well and is ultimately not important to the source node.

In one embodiment, the source node (e.g., 302 in FIG. 3) is the model for the objective function 202. The source node may depend on the optimal policy and additionally the source node may decompose into other elementary models. Each of those models may also decompose into further elementary models, and ultimately the most elementary models are functions of features 104. Finally, each feature 104, regarded as a random variable, is a function of the underlying probability space 106.

FIG. 3 illustrates a dependency graph for a decision system that may be used to decide the optimal price for a ride shown to a user of a ridesharing service. The nodes included are the node 302 for the expected revenue, node 304 for the conversion probability, node 306 for the price, node 308 for the supply, node 310 for the demand, and node 312 for the search. Working up from the bottom, the node 312 represents a search for a ride made by a user. Then features of that search, current supply represented by the node 308 of available rides and the current demand represented by the node 310 for rides from other users, are measured. The price represented by the node 306 is then determined according to a policy that depends on supply represented by the node 308 and demand represented by the node 310. In addition to the supply represented by the node 308 and the demand represented by the node 310, the policy 102 may optionally also make use of the model for expected revenue represented by the node 302 in conjunction with an optimization routine in order to discover the price that will maximize expected revenue. Many of the optimization routines are available through standard scientific computing libraries. After the price represented by the node 306 is determined, the conversion probability represented by the node 304 may be calculated as a function of the supply, the demand, and the price. Finally, the expected revenue represented by the node 302 is calculated from the conversion probability represented by the node 304 and the price represented by the node 306.

In one embodiment, at a high level, the system in the present disclosure determines that a policy 102 has poor performance if the model for the objective function 202 has a low accuracy when compared to the observed outcomes of the actual objective function 202.

In some embodiments, if the model agrees perfectly with the outcomes, this does not imply the policy 102 is optimal. Using the rideshare pricing example discussed above, a perfect model for revenue may exist, but an erroneous policy 102 may charge $0, even if the optimal price represented by the node 306 may have been $20. In this case, the expected revenue is $0, and so is the actual revenue. Thus, when the predictions are constrained to the chosen policy, the model is perfectly accurate.

In some embodiments, each node such as the nodes in FIG. 3 has a notion of intrinsic performance. For example, the intrinsic performance of a model node is the accuracy of the model node. In the case that the model is a binary classifier and outputs class probabilities, a more appropriate measure is its Brier score, which averages the outcomes in a local region and compares it with the predicted probability at a point in that region.

In one embodiment, for feature nodes such as nodes 308 and 310 in FIG. 3, a suitable measure of intrinsic performance may be the temporal drift of the distribution, and the correlation of the drift to the performance of the source node.

For the sample/population node such as node 312 in FIG. 3, a decent measure of performance may be the uniformity of frequencies that each sample is fed through the decision system. If one sample appears inordinately often, this is a cause for suspicion, and this node may be underperforming.

In an embodiment, an importance of a node such as nodes in FIG. 3 is how the variance of the node impacts the variance of dependent nodes of the node, all the way to the source node. There are multiple notions of feature importance that capture this, and the variety needed here may be model agnostic. The present system infers feature importance from its behavior in production as opposed to measuring feature importance based on statistics gathered during the model training process at least for a model node. Deducing feature importance by monitoring the graph produced by production data may involve locally perturbing function inputs in production and then performing a reduced sensitivity analysis. However, feature importance can also be inferred by analyzing behavior in a neighborhood of a given input to see how the model behaves locally.

In one embodiment, the utility of uncovering the graph-theoretic structure of a decision-making system is to systematize how to diagnose a performance of the decision-making system.

In one embodiment, a decision service is a decision system that is implemented either as a microservice or as a sequestered component of code. The top level function in a decision service accepts a sample from an underlying population or probability space as an argument and returns the decision from the decision space. Along the way, the decision service may need to gather features 104 of the sample and use those to calculate the recommended policy 102 that is returned.

In one embodiment, if the recommended policy 102 is derived from optimizing a model for the objective function 202, the system in the present disclosure may discover the dependency graph of the recommended policy, for the sake of performance diagnosis.

In one embodiment, the decision service in the present disclosure includes a function that calculates the objective function model even though the decision-making system may not have required it in the calculation of a near-optimal policy. For example, after the model for the objective function, as a function of an indeterminate decision parameter, has been formed, and after an optimization routine has discovered the decision that optimizes the model for the objective function, the decision system may output that optimal decision without first evaluating the model for the objective function at the optimal decision.

In one embodiment, the decision service in the present disclosure supports a mechanism for discovering the dependency graph in near real time. The decision service in the present disclosure supports a mechanism that enables us to compare predicted outcomes of the model nodes with their actual outcomes as they become observed after the decision has been made.

### 1.

### Dependency Graph Discovery.

In one embodiment, there are several ways to discover dependency graphs with the present system. Some options are configuration file, stack tracing, inferring dependency relationships from the nesting of logs generated by function calls as well as comparing input and output values of adjacent (non-nested) function calls, and hybrid methods with additional constraints on the code structure.

In one embodiment, the first option is the configuration file. An accompanying .yaml file is created which identifies (e.g. as an edge list) which functions in the code base play which roles in the dependency graph. However, this approach has the following drawbacks. A first drawback is the amount of time and effort required to maintain that mapping especially if the main body of code is constantly revised. A second drawback is the codebase may not intrinsically possess the correct graph structure, so it is not clear how to relate the nodes in the .yaml file with the corresponding code in the codebase. For example, whereas the top-level function in a decision service consumes a sample id and returns the nearly-optimal policy, no such node appears in the example graph above. Rather, in the dependency graph, only the features 104 themselves are direct functions of the sample id. Somehow, our solution needs to learn that some arguments may pass through some functions and get drawn only when they are explicitly used.

In one embodiment, the second option is the stack tracing. If the entire stack trace is captured and sent to a parser, a correct dependency graph may be algorithmically discovered.

While this puts the least burden on the user, it puts excessive burden on the parser, and there is no guarantee that a good algorithm can handle every possible code arrangement. As well, the volume of data transferred to the parser may be gargantuan compared to the amount of information necessary to discover the relevant graph structure and this may be insufficient.

In one embodiment, the second option is a hybrid with additional constraints on the code structure. A few constraints are placed on the structure of the code within the decision service and decorate relevant functions. This is described in detail below.

### Properties of Dependency Graph Discovery.

In one embodiment, an effective method of discovering the dependency graph solution has the following properties. A first property is that different coding implementations of the same decision service (e.g. the same inputs leading to the same outputs) may return identical dependency graphs.

A second property is that the graph is discoverable by an algorithm written in code, rather than manually. Other than having to identify which function represents the modeled objective function, it is neither required to specify which functions correspond to models and features 104, nor to identify the probability space or the decision space.

A third property is that the discovery process may not impact the latency of the decision service. For example, if the discovery process requires capturing data on a system that needs to calculate and serve decisions with low latency, and the discovery process then transmits the captured data to an external service for analysis, then the transmission time cannot interfere with the latency of the system producing the data.

A fourth property is that reconstructing the dependency graph is possible at any point in the future, not only on live traffic. This is essential for analyzing the performance of the decision system in terms of its internal nodes.

In one embodiment, the present system imposes a couple of constraints to the computer code that runs the decision system, such that the entire graph can be easily reconstructed quickly at any point in the future.

A first constraint is that the top level function represents the policy, returning a decision when passed a sample or features 104 of a sample.

A second constraint is that each function that corresponds to a node is regarded either as composite or primitive. It's possible that a function is regarded as neither, in which case it may not appear in the dependency graph. At a high level, a composite function node depends on whichever function generated its response value, and a primitive function depends on the functions that generated its arguments.

A third constraint is that a composite function satisfies some conditions. A first condition is that each of its arguments are passed to a composite or primitive function. A second condition is that the output of the composite function is generated by either a composite or primitive function. A third condition is that the composite function is wrapped with a decorator function that creates a unique identifier when it is called. The decorator function is a function that calls another, underlying function, gathers both the underlying value and unique identifier of that response (which necessarily, by definition of a composite function, is itself the result of either a primitive or composite function), and then associates that value and that dependency unique identifier with newly-created unique identifier by way of an asynchronous logger. The decorator function examines each argument of the underlying function, extracts its value and unique identifier if it is the result of either a primitive or composite function, and associates that value and dependent unique identifier with the newly-created unique identifier by way of an asynchronous logger.

In one embodiment, a function said to be “primitive” satisfies the following conditions. A first condition is that arguments of the primitive function may not be passed to the composite function or the primitive function. There is no constraint on the arguments of the primitive function. Each may be composite, primitive, or neither. The primitive function is wrapped in a decorator function that creates a unique identifier every time it is called. The primitive function is wrapped in the decorator function called the underlying function. The primitive function is wrapped in the decorator function that associates the response with the newly-created unique identifier by way of an asynchronous logger. The primitive function is wrapped in the decorator function, examines each argument, extracts its underlying value and unique identifier it is the result of either a composite or primitive function, and associates that value and dependent unique identifier with the newly-created unique identifier by way of an asynchronous logger.

In one embodiment, the top level function (the policy function) is wrapped in a decorator function that, after it calculates its response (e.g., a recommended decision), calls the function representing the objective function model, and logs it asynchronously with similar unique identifier associations as above.

With these requirements met, the dependency graph may be constructible entirely from the logged data, and it may then be possible to do all the analyses described throughout the present disclosure.

Referring to FIG. 4, this figure illustrates a dependency graph representation of an exemplary financial application of the system, according to an embodiment of the present disclosure.

In FIG. 4, node 402 represents a trading decision and node 404 represents financial signals. The node 402 includes a decision to buy, a decision to sell, or a decision to hold. The output of the function represented by the node 404 is the financial signals. The financial signals can be the input of the function for the trading decisions represented by the node 402.

Referring to FIG. 5, this figure illustrates another dependency graph representation of another exemplary financial application of the system, according to an embodiment of the present disclosure.

In FIG. 5, node 502 represents an expected value of position, node 504 represents trading decision, and node 506 represents financial signals. Similar to the discussion earlier in FIG. 4, the node 504 similar to the node 402 includes a decision to buy, a decision to sell, or a decision to hold. The output of the function represented by the node 506 is the financial signals. The financial signals can be the input of the function for the trading decisions represented by the node 504. The trading decision becomes the output of the function represented by the node 504 and the trading decision becomes the input of the function represented by the node 502 to determine an expected value of the position.

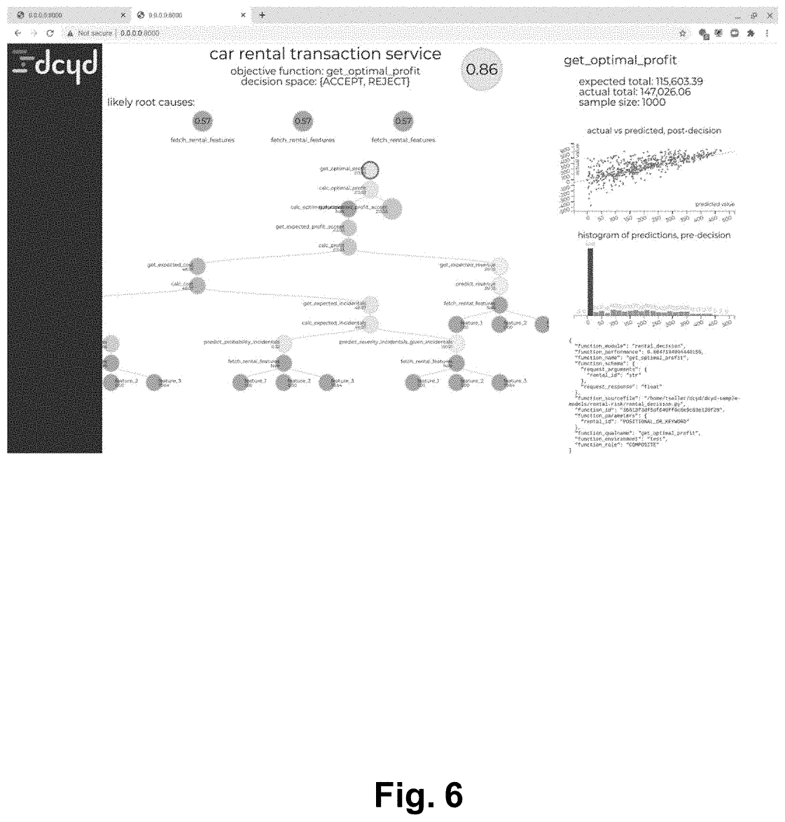

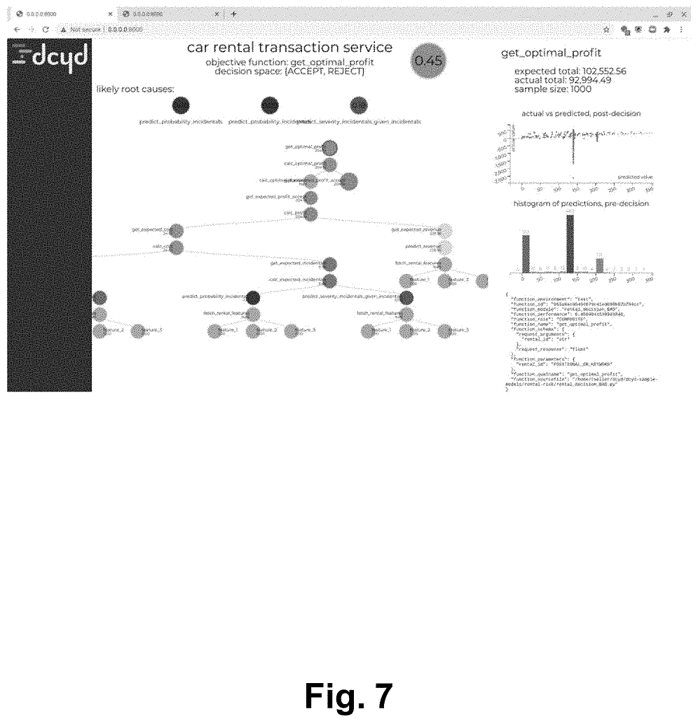

Referring to FIGS. 6 and 7, these figures illustrate interfaces generated by the system in the present disclosure that have parsed and drawn the resulting dependency graph, according to an embodiment of the present disclosure.

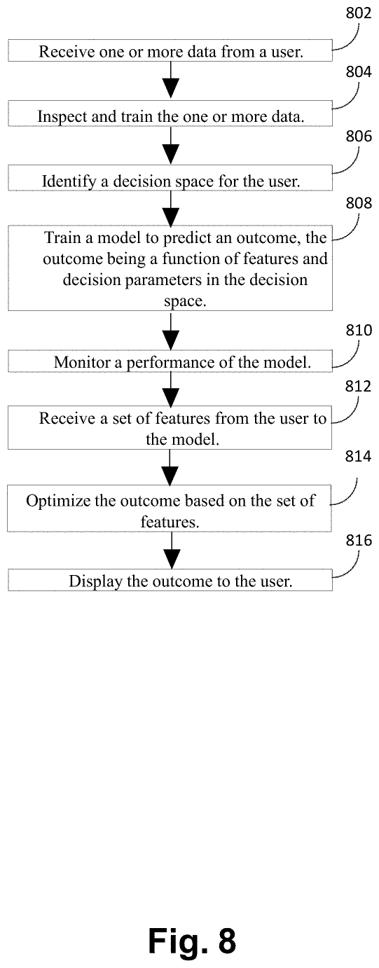

Referring to FIG. 8, this figure illustrates a flow chart of a system for decisions as a service (DASH) service, according to an embodiment of the present disclosure.

In another embodiment of the present disclosure, the decisions as a service (DASH) may be used to ask the users for their historical data and it generates an http endpoint that accepts facts about the decision being made and returns an optimal decision in a single click. The users may talk to the machine what's important to you, and the levers to be tuned, and artificial intelligence (AI) may do the rest. To accomplish this, an automated construction of a decision system has been used and the decision diagnostics has been plugged in to monitor the internals, identify what is needed to be repaired, whether it is a broken internal function that needs to be adjusted, or whether it's broken inputs that need to be repaired by the users. For example, a small car leasing company may want to decide which user is economically qualified to lease which cars. The small car leasing company may also want to make smart and automated decisions, and they want those decisions to be programmatically incorporated into the system.

At 802, the system receives one or more data by a user. The user uploads one or more data including training data. The training data includes historical decisions and their outcomes. For example, the training data may be “we approved a lease for a customer with these features 104, resulting in $50 profit” and “we rejected a lease for a customer with those features 104, resulting in $0 profit.

At 804, the DASH inspects the one or more data, and the one or more data may be the training data discussed in step 802.

At 806, the DASH identifies a decision space. For example, the decision space may be {approve, reject} in the case of leasing. The decision space may be {all nonnegative numbers} in the case of dynamic pricing.

At 808, the DASH trains a model to predict an outcome. The outcome is a function of the features 104 and decision parameters in the decision space. The DASH may train the set of models that predict the outcome as a function of the features 104 as well as the decision parameters.

At 810, a performance of the model may be monitored. The function used in predicting the outcome may include codes discussed above, so the performance of the model of the decision system may be monitored.

At 812, a set of features 104 from the user to the model is received. On an ongoing basis, when the user wants to receive an automated decision, the user supplies the features 104 excluding the decision parameters to the function discussed in step 808.

At 814, the outcome based on the set of features 104 is optimized. The DASH runs a routine which finds which values of the decision parameters optimizes the predicted outcome and returns those values along with the predicted outcome.

At 816, the outcome is displayed to the user. A dashboard is used to provide the user to review the past decisions and see an analysis that shows the reason for each decision to be expected to be optimal. The DASH continues the process, and the models are refactored and/or retrained to improve the optimality of the decisions.

In one embodiment, the DASH converts training data into a function that makes a decision as well as a prediction of the outcome of that decision. For example, the pricing engine at a rideshare company does not predict an optimal price. Rather, it predicts outcomes (e.g. revenue, profit) at multiple prices, and then selects the price that has the optimal predicted outcome. The DASH therefore requires that at least one of the features 104 be identified as a decision parameter. A feature that is not known at the time the function is called and must be tuned in order to maximize the predicted outcome. The DASH also requires that the target variable is a quantity that we wish to maximize or minimize such as revenue or profit since the optimization of the predicted outcome is used to select the optimal decision.

In one embodiment, a user interface is provided for a predictive model which allows the user to tune features 104 (e.g., the decision parameters). The features 104 are tuned to see the impact on the predicted outcome. The DASH then chooses optimal values for these decision parameters.

In one embodiment, when converting training data into a decision function in step 608, the DASH decomposes the problem into any assortment of models, followed by an optimization step. For example, if one use case is to select prices that optimize profits, several rows of historical data may show that a given price led to $0 in profit because the product was not purchased. In this case, the DASH may decompose the model that predicts profit into the multiplication of two models. A first model is to estimate the probability that a product gets purchased at a given price, and a second model is to estimate the profit given that it was purchased.

In one embodiment, the DASH includes a preliminary step of creating the function of the outcome to be optimized based on supplied historical data by the user as discussed in the step 602. The function is a predictive model for profit or revenue as a function of customer features 104 and the decision parameters.

In one embodiment, the DASH makes decisions one behalf of the user and optimizes objective function 202 on behalf of the user.

FIG. 9 is a schematic of a user device for performing a method for decision system diagnosis, according to an embodiment of the present disclosure.

An example of the user device 900 for decision system diagnosis is shown in FIG. 9. For example, the user device 900 can be a device provided to the user discussed earlier. FIG. 9 is also a detailed block diagram illustrating an exemplary electronic user device 900. In certain embodiments, the user device 900 may be a smartphone, a desktop computer, or a tablet. However, the skilled artisan will appreciate that the features described herein may be adapted to be implemented on other devices (e.g., a laptop, a tablet, a server, an e-reader, a camera, a navigation device, etc.). The exemplary user device 900 of FIG. 9 includes a controller 910 and a wireless communication processor 902 connected to an antenna 901. A speaker 904 and a microphone 905 are connected to a voice processor 903.

The controller 910 may include one or more Central Processing Units (CPUs) and one or more Graphics Processing Units (GPUs), and may control each element in the user device 900 to perform functions related to communication control, audio signal processing, graphics processing, control for the audio signal processing, still and moving image processing and control, and other kinds of signal processing. The controller 910 may perform these functions by executing instructions stored in a memory 950. Alternatively or in addition to the local storage of the memory 950, the functions may be executed using instructions stored on an external device accessed on a network or on a non-transitory computer readable medium. In the present disclosure, the controller 910 may control which types of data requests display on the screen of the user device 900. The controller 910 may be used to train data from the user. The controller 910 may be used to identify a decision space for the user based on the data that the user provided. For example, as discussed above, the controller 910 of the user device in the ridesharing company may determine that charging $10 may result in an amount of revenue higher than if they had charged any other price given the environmental conditions such as time of day.

The memory 950 includes but is not limited to Read Only Memory (ROM), Random Access Memory (RAM), or a memory array including a combination of volatile and non-volatile memory units. The memory 950 may be utilized as working memory by the controller 910 while executing the processes, formula, and algorithms of the present disclosure. The memory may store user inputs from the user device 900, e.g., a particular origin and destination specified by the user. Additionally, the memory 950 may be used for short-term or long-term storage, e.g., of image data and information related thereto

The user device 900 includes a control line CL and data line DL as internal communication bus lines. Control data to/from the controller 910 may be transmitted through the control line CL. The data line DL may be used for transmission of voice data, display data, etc.

The antenna 901 transmits/receives electromagnetic wave signals between base stations for performing radio-based communication, such as the various forms of cellular telephone communication. The wireless communication processor 902 controls the communication performed between the user device 900 and other external devices via the antenna 901. For example, the wireless communication processor 902 may control communication between base stations for cellular phone communication.

The speaker 904 emits an audio signal corresponding to audio data supplied from the voice processor 903. The microphone 905 detects surrounding audio and converts the detected audio into an audio signal. The audio signal may then be output to the voice processor 903 for further processing. The voice processor 903 demodulates and/or decodes the audio data read from the memory 950 or audio data received by the wireless communication processor 902 and/or a short-distance wireless communication processor 907. Additionally, the voice processor 903 may decode audio signals obtained by the microphone 905.

The exemplary user device 900 may also include a display 920, a touch panel 930, an operation key 940, and a short-distance communication processor 907 connected to an antenna 906. The display 920 may display the contents such as a corruption risk survey or questionnaires discussed earlier. The display 920 may be a Liquid Crystal Display (LCD), an organic electroluminescence display panel, or another display screen technology. In addition to displaying still and moving image data, the display 920 may display operational inputs, such as numbers or icons which may be used for control of the user device 900. The numbers or icons may be used for the respondent to answer the questionnaire. The display 920 may additionally display a GUI for a user to control aspects of the user device 900 and/or other devices. Further, the display 920 may display characters and images received by the user device 900 and/or stored in the memory 950 or accessed from an external device on a network. For example, the user device 900 may access a network such as the Internet and display text and/or images transmitted from a Web server.

The touch panel 930 may include a physical touch panel display screen and a touch panel driver. The touch panel 930 may include one or more touch sensors for detecting an input operation on an operation surface of the touch panel display screen. The touch panel 930 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 930 may detect when the stylus approaches/contacts the operation surface of the touch panel display (similar to the case in which a finger is used for the touch operation). The user of the user device 900 may use the touch panel 930 to answer the questions provided by the user device 900.

In certain aspects of the present disclosure, the touch panel 930 may be disposed adjacent to the display 920 (e.g., laminated) or may be formed integrally with the display 920. For simplicity, the present disclosure assumes the touch panel 930 is formed integrally with the display 920 and therefore, examples discussed herein may describe touch operations being performed on the surface of the display 920 rather than the touch panel 930. However, the skilled artisan will appreciate that this is not limiting.

For simplicity, the present disclosure assumes the touch panel 930 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 930 may include transparent electrode touch sensors arranged in the X-Y direction on the surface of transparent sensor glass.

The touch panel driver may be included in the touch panel 930 for control processing related to the touch panel 930, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 930 may detect a position of a user's finger around an edge of the display panel 920 (e.g., gripping a protective case that surrounds the display/touch panel). Signals may be transmitted by the touch panel driver, e.g. in response to a detection of a touch operation, in response to a query from another element based on timed data exchange, etc.

The touch panel 930 and the display 920 may be surrounded by a protective casing, which may also enclose the other elements included in the user device 900. In certain embodiments, a position of the user's fingers on the protective casing (but not directly on the surface of the display 920) may be detected by the touch panel 930 sensors. Accordingly, the controller 910 may perform display control processing described herein based on the detected position of the user's fingers gripping the casing. For example, an element in an interface may be moved to a new location within the interface (e.g., closer to one or more of the fingers) based on the detected finger position.

The operation key 940 may include one or more buttons or similar external control elements, which may generate an operation signal based on a detected input by the user. In addition to outputs from the touch panel 930, these operation signals may be supplied to the controller 910 for performing related processing and control.

The antenna 906 may transmit/receive electromagnetic wave signals to/from other external apparatuses, and the short-distance wireless communication processor 907 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 907.

The user device 900 may include a motion sensor 908. The motion sensor 908 may detect features of motion (i.e., one or more movements) of the user device 900. For example, the motion sensor 908 may include an accelerometer to detect acceleration, a gyroscope to detect angular velocity, a geomagnetic sensor to detect direction, a geo-location sensor to detect location, etc., or a combination thereof to detect motion of the user device 900. In certain embodiments, the motion sensor 908 may generate a detection signal that includes data representing the detected motion. For example, the motion sensor 908 may determine a number of distinct movements in a motion (e.g., from start of the series of movements to the stop, within a predetermined time interval, etc.), a number of physical shocks on the user device 900 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 910, whereby further processing may be performed based on data included in the detection signal. The motion sensor 908 can work in conjunction with a Global Positioning System (GPS) section 960. The information of the present position detected by the GPS section 960 is transmitted to the controller 910. An antenna 961 is connected to the GPS section 960 for receiving and transmitting signals to and from a GPS satellite.

The user device 900 may include a camera section 909, which includes a lens and shutter for capturing photographs of the surroundings around the user device 900. In an embodiment, the camera section 909 captures surroundings of an opposite side of the user device 900 from the user. The images of the captured photographs can be displayed on the display panel 920. A memory section saves the captured photographs. The memory section may reside within the camera section 909 or it may be part of the memory 950. The camera section 909 can be a separate feature attached to the user device 900 or it can be a built-in camera feature.

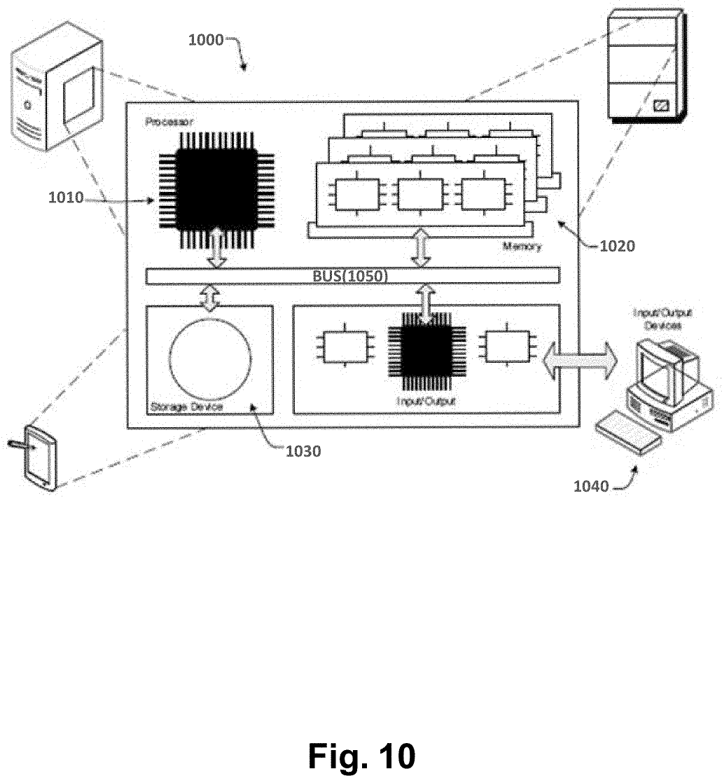

An example of a type of user's computer is shown in FIG. 10, which shows a schematic diagram of a generic computer system 1000. The user's computer may be a desktop computer for the ridesharing company described earlier.

The system 1000 can be used for the operations described in association with any of the method, according to one implementation. The system 1000 includes a processor 1010, a memory 1020, a storage device 1030, and an input/output device 1040. Each of the components 1010, 1020, 1030, and 1040 is interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

As discussed earlier, the processor 1010 may be used to identify the target. The processor 1010 may be used to determine a policy that optimizes the model as discussed earlier. The processor 1010 may be used to determine a price by the node 306 in the dependency graph in FIG. 3. The processor 1010 may execute the processes, formula, and algorithm in the present disclosure.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device. The storage device 1030 may store data requests including the misconduct data request, predictive factor data request, and social desirability data request as discussed earlier. The storage device 1030 may store surveys such as corruption risk survey discussed earlier. The storage device 1030 may store the response inputs from the respondents. The storage device 1030 may store user inputs from the user device 900, e.g., a particular origin and destination specified by the user.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

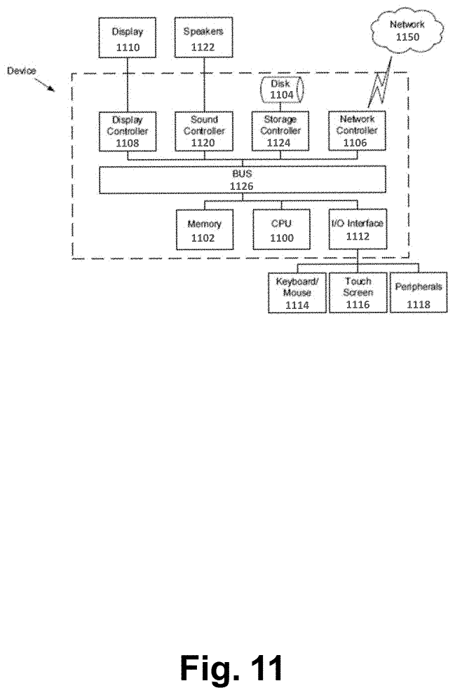

FIG. 11 is a schematic of a hardware configuration of a device for performing a method, according to an embodiment of the present disclosure.

Next, a hardware description of a device according to exemplary embodiments is described with reference to FIG. 11. In FIG. 11, the device includes processing circuitry which may in turn include a CPU 1100 which performs the processes described above/below. As noted above, the processing circuitry performs the functionalities of the process in the present disclosure. The processing circuitry may determine that a policy 102 has poor performance if the model for the objective function 202 has a low accuracy when compared to the observed outcomes of the actual objective function 202 as discussed earlier.

The process data and instructions may be stored in memory 1102. These processes and instructions may also be stored on a storage medium disk 1104 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 1100 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 1100 may be a Xenon or Core processor from Intel of America or an Opteron processor from AMD of America, or may be other processor types that would be recognized by one of ordinary skill in the art. Alternatively, the CPU 1100 may be implemented on an FPGA, ASIC, PLD or using discrete logic circuits, as one of ordinary skill in the art would recognize. Further, CPU 1100 may be implemented as multiple processors cooperatively working in parallel to perform the instructions of the processes described above.

The device in FIG. 11 also includes a network controller 1106, such as an Intel Ethernet PRO network interface card from Intel Corporation of America, for interfacing with network 1150. As can be appreciated, the network 1150 can be a public network, such as the Internet, or a private network such as an LAN or WAN network, or any combination thereof and can also include PSTN or ISDN sub-networks. The network 1150 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 1108, such as a NVIDIA GeForce GTX or Quadro graphics adaptor from NVIDIA Corporation of America for interfacing with display 1110, such as an LCD monitor. A general purpose I/O interface 1112 interfaces with a keyboard and/or mouse 1114 as well as a touch screen panel 1116 on or separate from display 1110. General purpose I/O interface also connects to a variety of peripherals 1118 including printers and scanners.

A sound controller 1120 is also provided in the device to interface with speakers/microphone 1122 thereby providing sounds and/or music.

The general purpose storage controller 1124 connects the storage medium disk 1104 with communication bus 1126, which may be an ISA, EISA, VESA, PCI, or similar, for interconnecting all of the components of the device. A description of the general features and functionality of the display 1110, keyboard and/or mouse 1114, as well as the display controller 1108, storage controller 1124, network controller 1106, sound controller 1120, and general purpose I/O interface 1112 is omitted herein for brevity as these features are known.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

What is claimed is:

1. A method for an analysis in a decision system, comprising:
receiving, by a processor, one or more data from a user;
inspecting, by the processor, the one or more data;
after inspecting the one or more data, training, by the processor, the one or more data;
identifying, by the processor, a decision space for the user based on the trained one or more data;
training, by the processor, a model to predict an outcome, the outcome being a function of features and decision parameters in the decision space;
monitoring, by the processor, a performance of the model in the decision system;
receiving, by the processor, a set of features from the user to the model;
optimizing, by the processor, the outcome based on the set of features; and
displaying the outcome to the user.

2. The method of claim 1, wherein the one or more data includes historical decisions and historical outcomes.

3. The method of claim 1, wherein the decision space includes one or more decisions corresponding to the trained one or more data in the decision system.

4. The method of claim 1, wherein the model is an objective function model.

5. The method of claim 1, wherein the user provides the set of features excluding the decision parameters to the function.

6. The method of claim 5, wherein the user receives an automated decision after providing the features excluding the decision parameters to the function.

7. The method of claim 1, wherein the outcome includes values of the decision parameters used to optimize the outcomes.

8. A system for an analysis in a decision system, comprising:
processing circuitry configured to
receive one or more data from a user;
inspect the one or more data;
after inspecting the one or more data, train the one or more data;
identify a decision space for the user based on the trained one or more data;
train a model to predict an outcome, the outcome being a function of features and decision parameters in the decision space;
monitor a performance of the model in the decision system;
receive a set of features from the user to the model;
optimize the outcome based on the set of features; and
display the outcome to the user.

9. The system of claim 8, wherein the one or more data includes historical decisions and historical outcomes.

10. The system of claim 8, wherein the decision space includes one or more decisions corresponding to the trained one or more data in the decision system.

11. The system of claim 8, wherein the model is an objective function model.

12. The system of claim 8, wherein the user provides the set of features excluding the decision parameters to the function.

13. The system of claim 12, wherein the user receives an automated decision after providing the features excluding the decision parameters to the function.

14. The system of claim 8, wherein the outcome includes values of the decision parameters used to optimize the outcomes.

15. A non-transitory computer-readable storage medium storing computer-readable instructions that, when executed by a computer, cause the computer to perform a method, the method comprising:
receiving one or more data from a user;
inspecting the one or more data;
after inspecting the one or more data, training the one or more data;
identifying a decision space for the user based on the trained one or more data;
training a model to predict an outcome, the outcome being a function of features and decision parameters in the decision space;
monitoring a performance of the model in the decision system;
receiving a set of features from the user to the model;
optimizing the outcome based on the set of features; and
displaying the outcome to the user.

16. The non-transitory computer-readable storage medium storing computer-readable instructions of claim 15, wherein the one or more data includes historical decisions and historical outcomes.

17. The non-transitory computer-readable storage medium storing computer-readable instructions of claim 15, wherein the decision space includes one or more decisions corresponding to the trained one or more data in the decision system.

18. The non-transitory computer-readable storage medium storing computer-readable instructions of claim 15, wherein the model is an objective function model.

19. The non-transitory computer-readable storage medium storing computer-readable instructions of claim 15, wherein the user provides the set of features excluding the decision parameters to the function.

20. The non-transitory computer-readable storage medium storing computer-readable instructions of claim 15, wherein the user receives an automated decision after providing the features excluding the decision parameters to the function.
